(19) United States
(12) Patent Application Publication
(10) Pub. No.: US 2007/0221039 A1
(43) Pub. Date: Sep. 27, 2007

(54) Moisture cap assembly for reed instruments

(76) Inventor: Robert W. Quaile SR., Somerdale, NJ (US)

Correspondence Address: Eugene E. Renz, Jr., P.C., 205 North Monroe Street, Post Office Box 2056, Media, PA, 19063-9056, US

(21) Appl. No.: 11/347,544

(22) Filed: Feb. 3, 2006

Related U.S. Application Data
(60) Provisional application No. 60/650,683, filed on Feb. 7, 2005.

(51) Int. Cl. G10D 9/02; G10D 7/00; G10D 9/00

(52) U.S. Cl. 84/383 R

(57) ABSTRACT

A cap for maintaining the reed of musical instruments moist when not in use comprising a cone shaped housing having an open end. An elongated slot is formed in the side wall of the housing. An offset compartment adjacent the closed end of the housing is provided for a flexible moisture pad. Means is provided for frictionally holding the mouthpiece in the cap with the reed confronting and engaging the moisture pad to wet the reed when the instrument is not in use.

This application claims the benefit of U.S. Provisional Application No. 60/650,683 filed Feb. 7, 2005.

### FIELD OF THE INVENTION

The present invention relates to improvements in accessories for woodwind instruments and more specifically to a cap assembly characterized by novel features of construction and arrangement for maintaining the reed of a woodwind instrument moist when it is not in use.

### BACKGROUND OF THE INVENTION

The reed of a woodwind instrument needs to be kept moist for the instrument to yield the best sound. In the normal course of use, the reed is moistened by the user's saliva and maintained moist so long as the instrument is being played. However many woodwind players use more than one instrument during an engagement, commonly referred to as, “Doubling.” Accordingly, the problem arises in connection with the instrument not being used for a segment of a song or perhaps several which results in the reed drying out. It has been observed especially for theater musicians that the change from one instrument to another has to be done very quickly with no time to moisten the reed of the instrument which has dried out somewhat during a rest period.

The present invention provides a mouthpiece cap assembly designed to keep the reed moistened while the musician is, “Doubling.”

### SUMMARY OF THE INVENTION

With the foregoing in mind, it is an object of the present invention to provide a novel cap assembly characterized by features of construction and arrangement for mounting over the mouthpiece of a wind instrument and hold it firmly in place so that the reed to presses against a pad made of a flexible water absorbent material when the instrument is not in use. This keeps the reed moist while the cap is in place. The cap may be made of a flexible plastic material and is cone shaped to conform generally to the tapered shape of the mouthpiece of the instrument. At least one slot is formed in the side wall of the cap to define an open channel providing clearance for the screws for regulating pressure on the band surrounding the mouthpiece. The screws engaging in the channel aligns the mouthpiece for engagement of the reed and the moisture pad mounted in a radially offset compartment in the closed end of the cap.

Elongated strengthening ribs may be provided on the exterior of the cap running generally parallel to the screw slots. Further, the slots may have a key hole shape at the inner closed end of the cap defining expansion slots to allow slight deflection or expansion when the mouthpiece is inserted to better seat the mouthpiece in the cap.

### BRIEF DESCRIPTION OF THE DRAWINGS

These and other objects of the present invention and the various features and details of the operation and construction thereof are hereinafter more fully set forth with reference to the accompanying drawings, wherein;

FIG. 1a is a perspective view of a mouthpiece of a wind instrument such as a clarinet or saxophone and a cap assembly in accordance with the present invention for keeping the reed moist when not in use by the musician;

FIG. 1b is a perspective view showing the mouthpiece fully assembled in the cap assembly of the present invention;

FIG. 2 is an elevational view of the cap assembly;

FIG. 3 is a transverse sectional view of the cap assembly taken on lines 3-3 of FIG. 2;

FIG. 4 is a side elevational view of the cap assembly;

FIG. 5 is a bottom plan view of the cap assembly as viewed along lines 5-5 of FIG. 4;

FIG. 6 is a end elevational view as viewed along lines 6-6 of FIG. 4;

FIG. 7 is a side elevational view of the cap assembly with the mouthpiece in place;

FIG. 8 is a bottom plan view showing the mouthpiece mounted in the cap assembly;

FIG. 8a is an enlarged view of the instrument and of the mouthpiece and cap assembly of the portion circled in FIG. 8 designated by the numeral 8a;

FIG. 9 is a transverse sectional view taken along lines 9-9 of FIG. 8 showing the instrument mouthpiece in place with the reed engaging the moist sponge;

FIG. 10 is an end elevational view of another embodiment of cap assembly in accordance with the present invention;

FIG. 11 is an enlarged transverse sectional view taken on lines 11-11 of FIG. 10;

FIG. 12 is a cross sectional view similar to FIG. 11 showing the mouthpiece for an instrument fully seated in the cap assembly with the reed of the mouthpiece engaging the moist sponge;

FIG. 13 is an end view of another embodiment of cap assembly in accordance with the present invention;

FIG. 14 is an enlarged transverse sectional view taken on lines 14-14 of FIG. 13; and

FIG. 15 is a view similar to FIG. 14 with the mouthpiece engaged in the cap assembly so that the reed engages the moist sponge.

### DESCRIPTION OF PREFERRED EMBODIMENTS

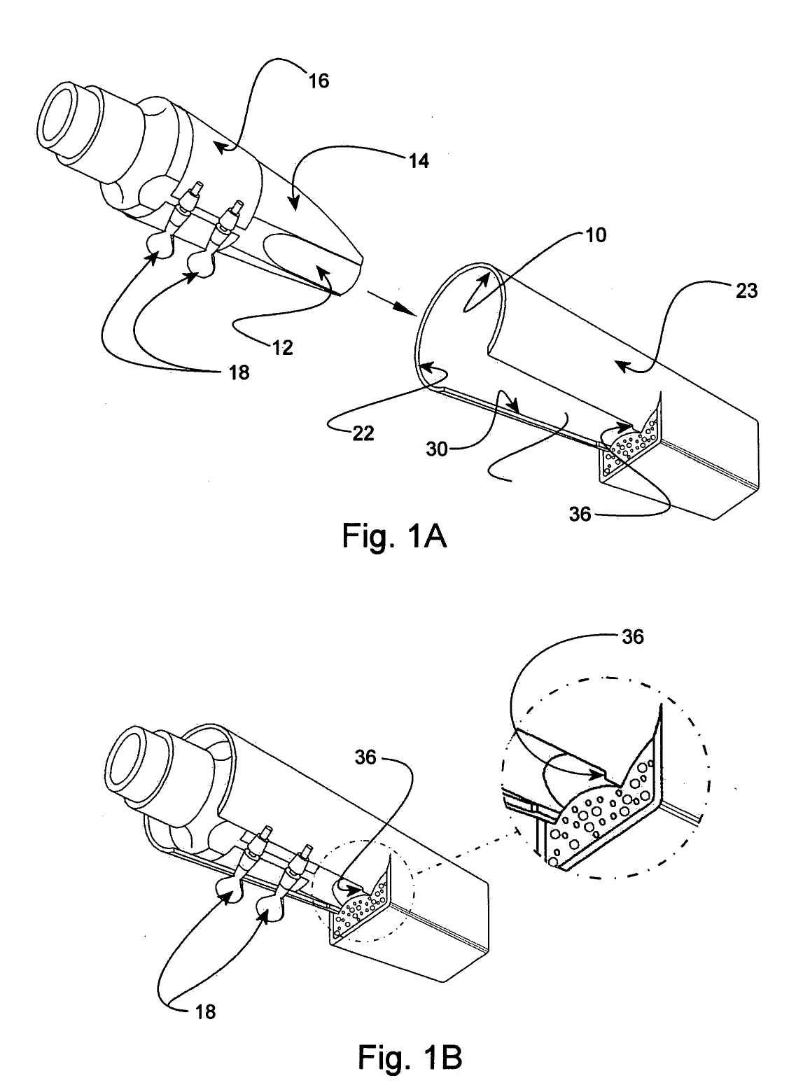

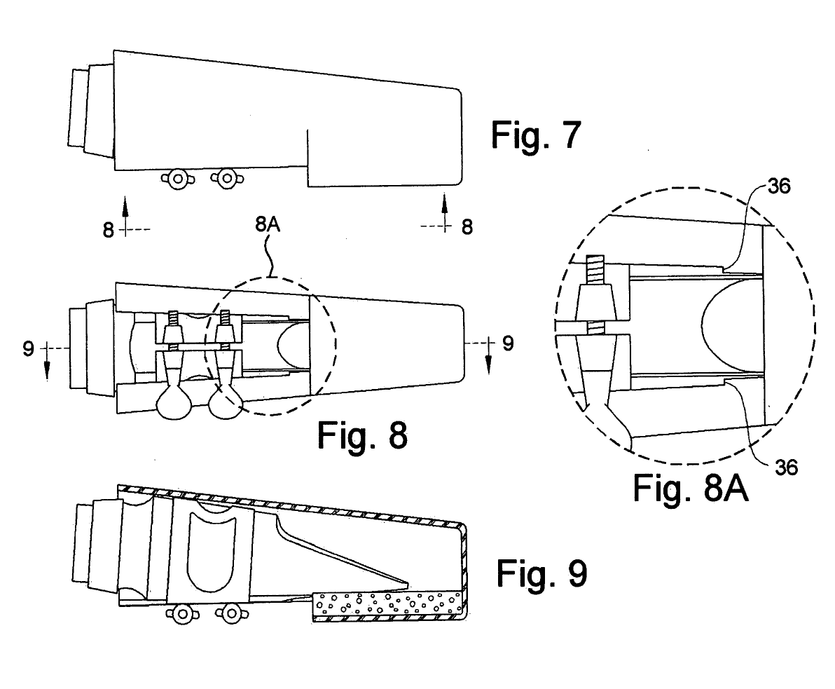

Referring now to the drawings and particularly to FIGS. 1-9 thereof, there is shown a cap assembly in accordance with the present invention generally designated by the numeral (10). The cap assembly (10) is characterized by novel features of construction and arrangement and is adapted for use to maintain the reed (12) of a mouthpiece (14) for a wind instrument such as a clarinet or a saxophone moist when not in use by the musician. As is typical, the reed (12) is held in place in the mouthpiece by a band (16) and two (2) adjustable screws (18) to tighten the band (16) and keep the reed (12) in place in the mouthpiece. The reed (12) can be replaced when needed by simply loosening the screw fasteners (18) which expands the band (16) and permits the reed to be removed from the slotted groove in mouthpiece forming a seat for the reed (12).

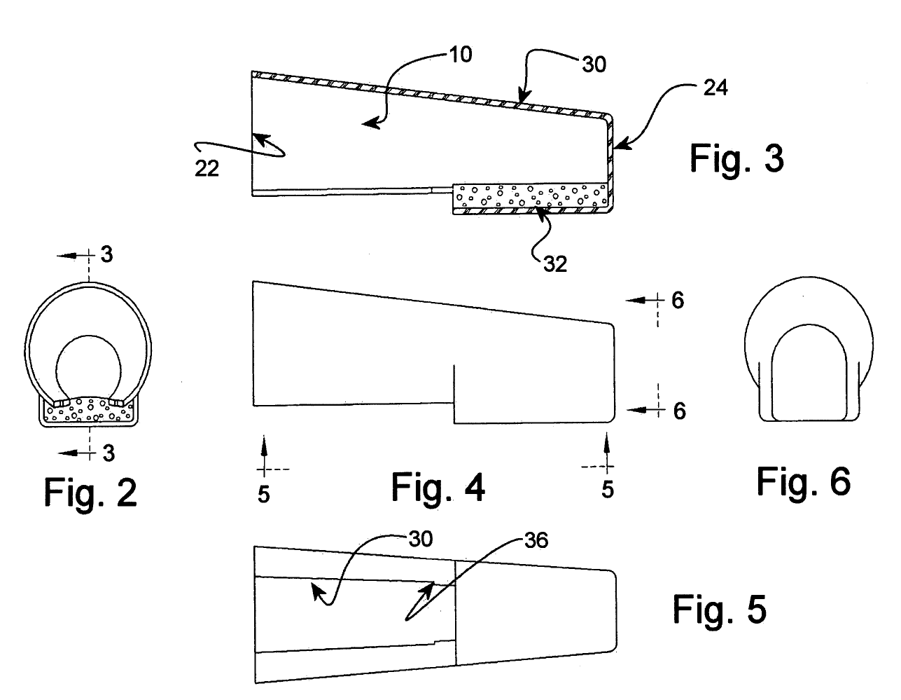

The cap assembly (10) as best illustrated in FIGS. 2-6 inclusive is made of a plastic material and comprises an elongated hollow housing (20) open at one end (22) and closed at the opposite end by an end wall (24). The housing (20) is cone shaped and of generally circular cross section and tapers toward the closed end (24) and is sized relative to the cross section of the mouthpiece (14) to snugly embrace the mouthpiece (14) when the cap is positioned over the mouthpiece (14) of an instrument in the manner shown in FIG. 9. The side wall 23 of the housing (20) has a slot (30) formed therein extending from the open end (22) to an enlarged semicircular bay section (32) which houses a sponge (34) or pad to hold a quantity of liquid such as water for keeping the reed moist when the cap is assembled over the mouthpiece (14) in the manner shown in FIG. 9. The slot (30) defines a trackway for accommodating the fastening elements (18) which protrude beyond the outer edge of the slot (30) in the manner shown in FIG. 9. The slot (30) is stepped as at (36) to form an abutment which the band (16) engages and prevents over-insertion of the mouthpiece into the cap assembly which could result in damage to the feathered inner edge of the mouthpiece (14).

In the present instance, the conical tapered configuration of the mouthpiece complements the tapered inner peripheral wall (21) of the housing (20) so that when the mouthpiece (14) is inserted in the housing (20), it is seated by a frictional fit since the slot (30) provides a degree of resiliency. The screws (18) and slot (30) align the mouthpiece (14) so that when sealed in the cap, the reed (12) is aligned with and presses against the moisture pad (34).

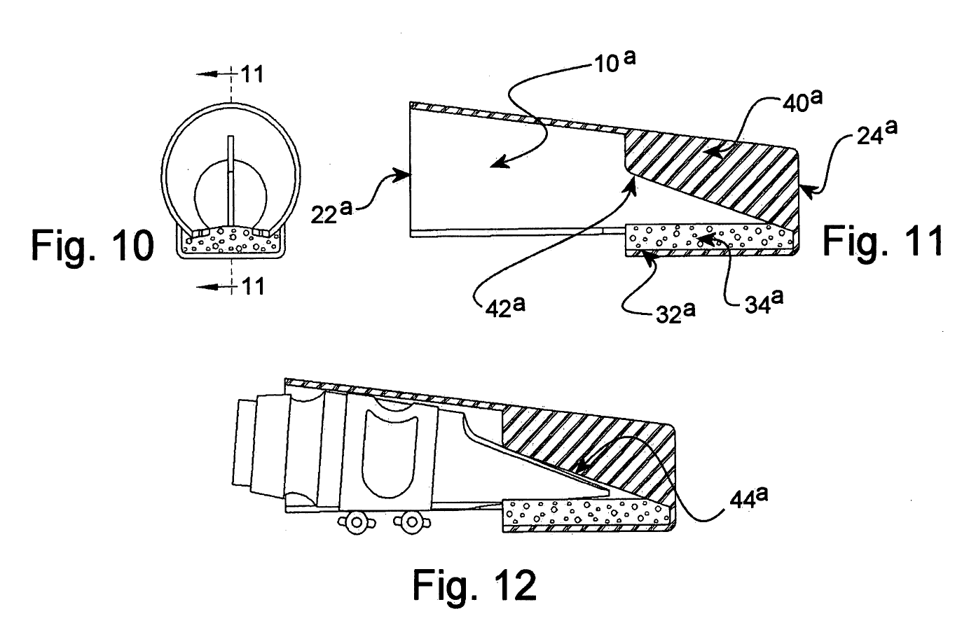

There shown in FIGS. 10-12 inclusive another embodiment of cap assembly for maintaining the reed of a mouthpiece moist during periods of non use which is generally similar to the main embodiment. Accordingly, the same reference numerals have been applied to corresponding parts similar to the principal embodiment of FIGS. 1-9 inclusive. The subscript “a” is added. The cap assembly (10a) includes a housing (20a) which is of generally circular cross section and tapers from an open end (22a) to the closed end (24a) and has an elongated slot (30a) extending from the open end to a point adjacent the bay (32a). In accordance with this embodiment of the invention, the cap housing (20a) includes an internal rib (40a) having a tapered edge (42a) which as shown in FIG. 10 extends approximately the length of the sponge bay (32a) and is generally centrally located with respect to the trackway (30a). The edge (42a) is tapered approximately the same angle as the lower face 44a of the mouthpiece 14a so that when the cap 10a is positioned over the mouthpiece 14a in the manner shown in FIG. 12, the tapered portion (44a) of the mouthpiece engages the tapered edge (42a) of the rib (40a) pressing the reed in contact with the moisture pad (34a).

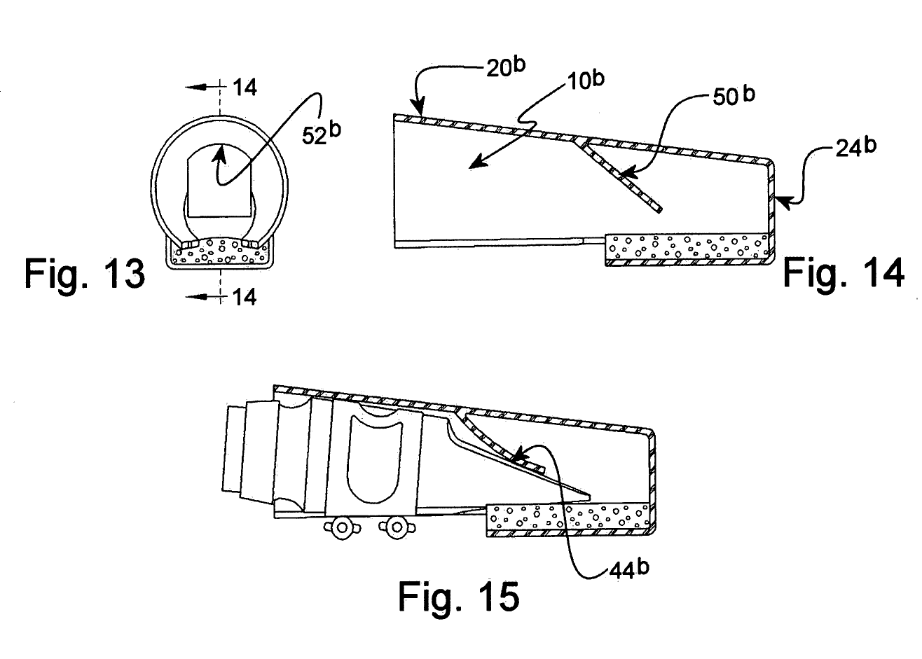

There is shown in FIGS. 13-15 inclusive another embodiment of cap assembly in accordance with the present invention. The overall configuration of the cap assembly is generally similar to the previously described embodiments and accordingly the same reference numerals with a “b” subscript have been used to identify similar parts. Thus, the cap assembly (10b) comprises a hollow housing (20b) having an end wall (24b), a bay (32b) for moisture pad (34b). In accordance with this embodiment, a flexible flap (50b) of generally rectangular shape is formed integrally with the inner wall of the housing along its arcuate top edge (52b) and protruding downwardly and rearwardly toward the end wall (24b) at a predetermined angle so that when the mouthpiece is inserted into the cap in the manner shown in FIG. 15, the flap (50b) frictionally engages the beveled underside of the mouthpiece when fully seated in the cap to press the reed of the mouthpiece to engage the sponge (34b) to moisten the reed in a manner described above.

Even though particular embodiments of the invention have been illustrated and described herein, it is not intended to limit the invention and changes and modifications may be made therein within the following claims. For example, the side wall of the housing may have diametrically opposing slots to accommodate mouthpiece assemblies having split band and two sets of clamping screws. Further, the housing may be rigidify by at least one elongated stiffener rib formed in the outer surface of the conical housing and generally aligned with the central axis of the housing. Further, the adjusting screw slot may be provided with smaller key hole expansion slots to allow a limited expansion of cap if the mouthpiece is forced into the cap.

What is claimed is:

1. A cap for maintaining the reed of musical instruments moist when not in use comprising a cone shaped housing having an open end and a closed end means defining an elongated slot in the side wall of the housing, an offset compartment, adjacent the closed end of the housing for a flexible moisture pad and means for frictionally holding the mouthpiece in the cap with the reed confronting and engaging the moisture pad to wet the reed when the instrument is not in use.

2. A cap as claimed in claim 1 wherein said moisture pad is made of a flexible foam material.

3. A cap as claimed in claim 1 including a tapered rib on the inner surface of the housing adjacent the closed end engagable by the tapered face of the mouthpiece to frictionally hold the mouthpiece with the reed confronting and pressing the moisture pad.

4. A cap assembly as claimed in claim 1 wherein said housing mounts a flexible lip on its inner wall diametrically opposed to the moisture pad which deflects when the mouthpiece is inserted and is held in place with the reed confronting and engaging the moisture pad.
